(19) United States
(12) Patent Application Publication
(10) Pub. No.: US 2010/0154018 A1
(43) Pub. Date: Jun. 17, 2010

(54) METHOD AND APPARATUS FOR TRANSMITTING PACKET FILTERING INFORMATION

(76) Inventors: Yong Seong CHO, Daejeon (KR); Taekyoon KIM, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/548,777

(22) Filed: Aug. 27, 2009

(30) Foreign Application Priority Data
Dec. 16, 2008 (KR) 10-2008-0127937

(51) Int. Cl. H04N 7/173; G06F 15/16

(52) U.S. Cl. 725/111; 709/249

(57) ABSTRACT

Disclosed are a method and an apparatus of transmitting packet filtering information. A DSG channel information management server included in a digital cable broadcasting transmission headend combines a packet address and information related to the packet address and generates the combined information to be a single file, the packet address being used for filtering packets received by a cable modem contained in a cable broadcasting receptor, for each data type. The generated file is transmitted from a CMTS to the cable modem through a packet having a designated address mutually agreed upon between the headend and the cable modem, the cable modem obtains information for selectively filtering the received packets, from the received file, and constructs a filter. Data selectively filtered through each constructed filter is transmitted to a corresponding process module included in the cable broadcasting receptor that processes broadcasting program information, conditional access information, and the like.

### CROSS-REFERENCE TO RELATED APPLICATION

This application claims the benefit of Korean Patent Application No. 10-2008-0127937, filed on Dec. 16, 2008, in the Korean Intellectual Property Office, the disclosure of which is incorporated herein by reference.

### BACKGROUND

1. Field of the Invention

The present invention relates to a method and an apparatus of transmitting packet filtering information.

2. Description of the Related Art

A U.S. standard off-cable scheme transmits additional broadcasting information providing various service information, such as system information (SI), electronic program guide (EPG) information, conditional access information, an emergency alarm, video on demand (VOD), a game, and the like, together with a broadcasting program via an out-of-band in a bidirectional digital environment.

Also, when a digital cable broadcasting receptor intends to receive the broadcasting additional information transmitted via the out-of-band, a method that selectively separates general data and broadcasting additional information data, the general data being transmitted to a Data Over Service Interface Specification (DOCSIS) channel through a Cable Modem Termination System (CMTS) and the broadcasting additional information data being processed by a cable broadcasting receptor, is standardized in a DOCSIS set-top Gateway (DSG).

A set-top controller is a device for transmitting the broadcasting additional data over a cable network, and examples of the set-top controller include an SI server, a conditional access system server, and the like. Data of the set-top controller is transmitted to a CMTS of a cable headend in a form of an Internet protocol (IP) multicast over an IP network, and a DSG module contained in the CMTS transmits, to each subscriber connected to the cable network, the data received from the set-top controller in a form of a multicast. In this instance, the DSG module contained in the CMTS changes a destination media access control (MAC) address into a DSG tunnel address, the destination MAC address being included in each packet transmitted from the set-top controller to the subscriber. The DSG tunnel address is important information utilized for classifying the broadcasting additional data, such as SI data, conditional access data, and the like, transmitted on a DOCSIS channel. Also, the cable broadcasting receptor, containing a cable modem having a DSG function, determines a type of the inputted broadcasting additional information by utilizing a corresponding address value as data filtering information, and the cable broadcasting receptor also determines a process method for the inputted broadcasting additional information.

The DSG standard is divided into one of a DSG basic mode and a DSG advanced mode depending on a DSG tunnel address setting and operating method.

The DSG basic mode stores information with respect to the DSG tunnel address in a cable card that a cable broadcasting operator distributes to a subscriber, to enable the cable broadcasting receptor containing the cable modem to selectively receive desired broadcasting additional data. As the cable card is operating after being inserted to the cable broadcasting receptor, the corresponding information is transmitted to the cable modem, and the cable modem constructs a DSG tunnel filter based on the corresponding information, thereby receiving the desired broadcasting additional data.

Conversely, the DSG advanced mode transmits the DSG tunnel address and related information to the cable modem from the CMTS through a downstream channel descriptor (DCD) that is a specially defined as a DOCSIS MAC management message, and the cable modem that receives the DCD message constructs a DSG tunnel filter based on the information included in the DCD message, thereby receiving desired broadcasting additional data.

Differences between the DSG basic mode and the DSG advanced mode are as follows.

In the DSG basic mode, when the DSG tunnel address is changed due to a change of a system, such as a server providing broadcasting additional data, and the like, it is difficult to change DSG tunnel address information of a cable card distributed to the subscriber in advance because the DSG tunnel address designated in the CMTS of the broadcasting headend is distributed in a form stored in the CMTS. Also, a current open-cable standard limits a number of the DSG tunnel addresses to be defined by the DSG basic mode as eight, thereby having a difficulty in enlarging the system.

Conversely, in the DSG advanced mode, information related to DSG tunnel construction is transmitted to the cable modem contained in the cable broadcasting receptor through the DCD that is one of DOCSIS MAC management messages, and thus, it is convenient to change and enlarge the DSG channel construction when the system in the broadcasting headend is changed.

However, to use the DSG advanced mode, all devices operated in the current DSG basic mode are required to be replaced with devices operated in the DSG advanced mode.

### SUMMARY

An aspect of the present invention provides a method of transmitting Data Over Service Interface Specification (DOCSIS) set-top Gateway (DSG) channel construction information to a designated channel without replacing devices operated in a DSG basic mode, such as a cable modem termination system (CMTS), a cable modem, and the like, with devices in a DSG advanced mode, thereby dynamically constructing a DSG channel even in a device in the DSG basic mode.

According to example embodiments, there may be provided a method of controlling a DSG channel information server, including generating a DSG channel information message including a destination media access control (MAC) address used for filtering packets for each data type, the destination MAC address being included in each of the packets, and transmitting the DSG channel information message to a cable broadcasting receptor using a predetermined multicast address.

In this instance, the transmitting of the DSG channel information message may include providing the DSG channel information message to a CMTS, and transmitting, by a DSG module included in the CMTS, the DSG channel information message in a form of a multicast to the cable broadcasting receptor.

Also, the DSG channel information message may include information used for filtering the packets for each data type.

Also, the DSG channel information message may include a DSG channel information message header including identification information of the DSG channel information message, and DSG channel information data including DSG channel information.

Also, the DSG channel information message header may include a message identification (ID) to identify the DSG channel information message, a change counter being capable of determining whether the DSG channel information message is changed by changing a value according to a change of the DSG channel information, and a number of fragments and a fragment number to provide connection information of the DSG channel information message header.

Also, the DSG channel information data may include a number of DSG tunnels being information related to the number of the DSG tunnels constructed from a broadcasting headend, and DSG tunnel information including filtering information of the DSG tunnels.

Also, the DSG tunnel information may include a DSG tunnel MAC address to be used for identifying and filtering broadcasting additional information data, a DSG tunnel Internet protocol (IP) address to provide a source IP address of a server that transmits the DSG channel information data, and a DSG data type to represent a data type of the DSG channel information data.

According to example embodiments, there may be provided a method of controlling a CMTS, the method including receiving a DSG channel information message including a destination MAC address used for filtering packets for each data type, the destination MAC address being included in each of the packets, and transmitting, by a DSG module, the DSG channel information message in a form of a multicast, to a cable broadcasting receptor.

In this instance, the transmitting of the DSG channel information message may include changing, by the DSG module, the destination MAC address into a DSG tunnel address, and transmitting the DSG channel information message including the destination MAC address in the form of the multicast, to a cable broadcasting receptor.

Also, the transmitting of the DSG channel information message may include selecting, by the DSG module, a predetermined address from a multicast address area, and transmitting the DSG channel information message in the form of the multicast, to the cable broadcasting receptor.

According to example embodiments, there may be provided a method of controlling a cable broadcasting receptor, the method including receiving a DSG channel information message transmitted in a form of a multicast via a DSG tunnel corresponding to a predetermined DSG tunnel address, constructing a DSG channel filter that performs filtering of received data using the DSG channel information message, and receiving data filtered by the DSG channel filter.

In this instance, the filtered data may include broadcasting additional information including at least one of system information (SI), conditional access information, and electronic program guide (EPG) information.

According to example embodiments, there may be provided a DSG channel information server, including a DSG channel information message generating unit to generate a DSG channel information message including a destination MAC address used for filtering packets for each data type, the destination MAC being included in each of the packets, and a transmitting unit to transmit the DSG channel information message to a cable broadcasting receptor using a predetermined multicast address.

In this instance, the transmitting unit may provide the DSG channel information message to a CMTS and may enable a DSG module included in the CMTS to transmit the DSG channel information message in a form of a multicast to a cable broadcasting receptor.

According to example embodiments, there may be provided a CMTS, including a receiving unit to receive a DSG channel information message including a destination MAC address used for filtering packets for each data type, the destination MAC address being included in each of the packets, and a DSG module to transmit the DSG channel information message in a form of a multicast to a cable broadcasting receptor.

In this instance, the DSG module may change the destination MAC address into a DSG tunnel address, and may transmit the DSG channel information message including the destination address in the form of the multicast to the cable broadcasting receptor.

Also, the DSG module may select a predetermined address from a multicast address area, and may transmit the DSG channel information message in the form of the multicast to the cable broadcasting receptor.

According to example embodiments, there may be provided a cable broadcasting receptor, including a cable modem to receive a DSG channel information message transmitted in a form of multicast through a DSG tunnel corresponding to a predetermined DSG tunnel address, and a DSG channel filter constructing unit to construct a DSG channel filter to perform filtering of received data using the DSG channel information message. Here, the cable modem receives data filtered through the DSG channel filter.

In this instance, the filtered data may include broadcasting additional information including at least one of system information (SI), conditional access information, and EPG information.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a configuration diagram illustrating a digital cable broadcasting system according to an embodiment of the present invention;

FIG. 2 is a configuration diagram illustrating a Data Over Service Interface Specification (DOCSIS) set-top Gateway (DSG) channel information sever according to an embodiment of the present invention;

FIG. 3 is a configuration diagram illustrating a cable modem termination system (CMTS) according to an embodiment of the present invention;

FIG. 4 is a configuration diagram illustrating a cable broadcasting receptor according to an embodiment of the present invention;

FIG. 5 is a diagram illustrating a configuration of a DSG channel information message that is provided by a DSG channel information server, according to an embodiment of the present invention;

FIG. 6 is a diagram illustrating a method of changing a destination media access control (MAC) address of a DSG channel information server packet in a CMTS, according to an embodiment of the present invention;

FIG. 7 is a flowchart illustrating a method of controlling a DSG channel information server according to an embodiment of the present invention;

FIG. 8 is a flowchart illustrating a method of controlling a CMTS according to an embodiment of the present invention; and

FIG. 9 is a flowchart illustrating a method of controlling a cable broadcasting receptor according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

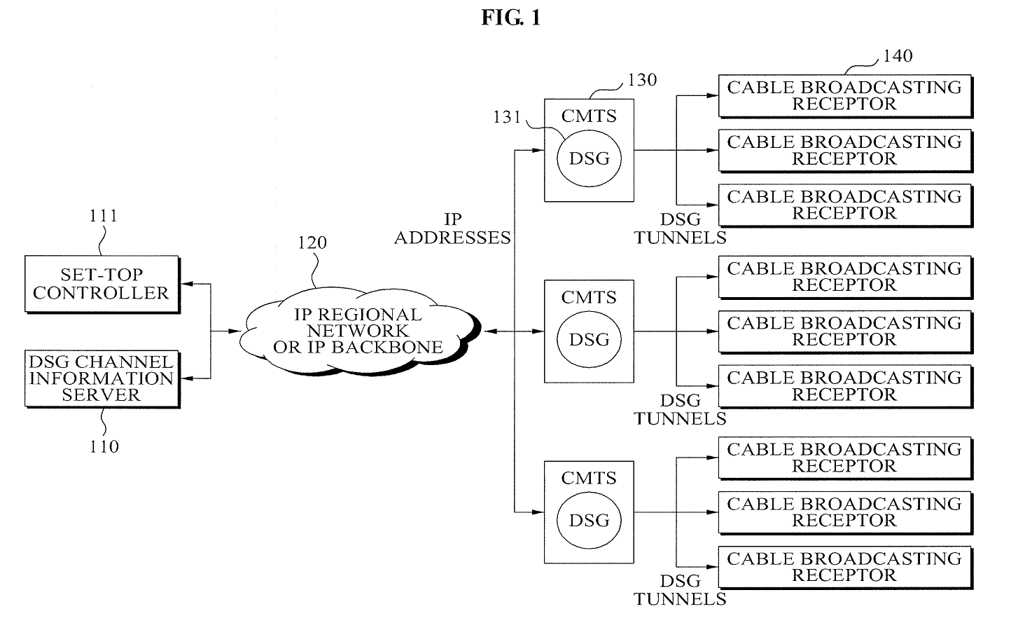

FIG. 1 is a configuration diagram illustrating a digital cable broadcasting system according to an embodiment of the present invention. The digital cable broadcasting system according will be described in detail with reference to FIG. 1.

The digital cable broadcasting system according to an embodiment of the present invention may include a DSG channel information server 110 providing Data Over Service Interface Specification (DOCSIS) set-top Gateway (DSG) channel information, a set-top controller 111, a cable modem termination system (CMTS) 130, and a digital cable broadcasting receptor 140.

In the cable broadcasting system, the DSG channel information server 110 may generate a DSG channel information message used for dynamically transmitting the DSG channel information to a broadcasting receptor from a broadcasting headend, and may output the DSG channel information message to a cable broadcasting receptor 140 using a multicast address designated in the CMTS 130.

The set-top controller 111 may provide broadcasting additional information, such as system information (SI), conditional access information, electronic program guide (EPG) information, and the like. A DSG channel information message generated from the set-top controller 111 is transmitted to the CMTS 130 of a cable headend in a form of an Internet protocol (IP) multicast over an IP network 120.

The CMTS 130 may receive the DSG channel information message from the DSG channel information server 110, and DSG module 131 included in the CMTS 130 changes a destination MAC address of a packet including the received DSG channel information message into a DSG channel address designated as an invariable value.

Also, the CMTS 130 may output the DSG channel address, which is changed into the invariable value, to the cable broadcasting receptor 140 over a cable network.

In this instance, an address mutually agreed upon between the broadcasting headend and the cable broadcasting receptor is freely selected from a multicast address area as the DSG tunnel address used for transmitting the DSG channel information.

The cable broadcasting receptor 140 containing a cable modem may receive the DSG channel construction information message using the designated DSG tunnel address, and may construct a DSG channel filter based on the received DSG channel construction information message.

When construction of the DSG channel filter is completed, the broadcasting additional information, such as SI information, conditional access information, and the like, based on the corresponding address information is received.

Therefore, exemplary embodiments of the present invention may transmit DSG channel construction information to a designated channel without replacing the devices operated in the DSG basic mode, such as a CMTS, a cable modem, and the like, with devices of DSG advanced mode, and thus the DSG channel may be dynamically constructed even in a device in a DSG basic mode.

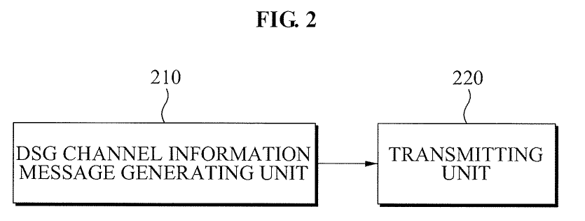

FIG. 2 is a configuration diagram illustrating a DSG channel information sever according to an embodiment of the present invention.

As illustrated in FIG. 2, the DSG channel information server may include a DSG channel information message generating unit 210 and a transmitting unit 220.

The DSG channel information message generating unit 210 generates a DSG channel information message. In this instance, the DSG channel information message includes a destination MAC address used for filtering packets for each data type, the destination MAC address being included in each of the packets.

The transmitting unit 220 transmits the generated DSG channel information message to a cable broadcasting receptor using a predetermined multicast address.

Particularly, the transmitter 220 may provide the DSG channel information message to a CMTS, and the CMTS may transmit the DSG channel information message in a form of a multicast to the cable broadcasting receptor using a DSG module included in the CMTS.

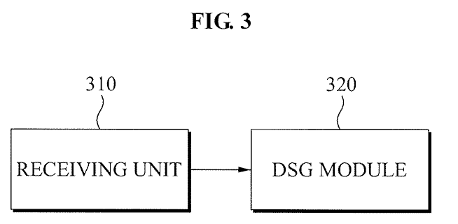

FIG. 3 is a configuration diagram illustrating a CMTS according to an embodiment of the present invention.

As illustrated in FIG. 3 the CMTS may include a receiving unit 310 and a DSG module 320.

The receiving unit 310 receives a DSG channel information message including a destination MAC address of a packet.

The DSG module 320 transmits the DSG channel information message in a form of a multicast to a cable broadcasting receptor.

In this instance, the DSG module 320 changes the destination MAC address of the packet into a DSG tunnel address, and transmits the DSG channel information message including the destination MAC address of the packet in the form of the multicast to the cable broadcasting receptor.

Also, the DSG module 320 selects a predetermined address from a multicast address area and transmits the DSG channel information message in the form of the multicast to the cable broadcasting receptor.

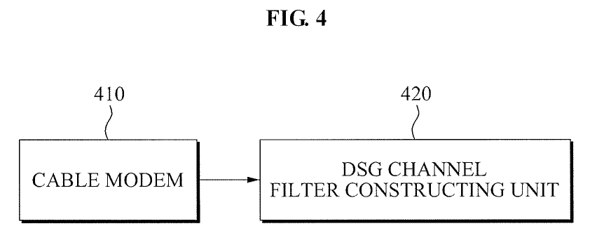

FIG. 4 is a configuration diagram illustrating a cable broadcasting receptor according to an embodiment of the present invention.

As illustrated in FIG. 4, the cable broadcasting receptor may include a cable modem 410, and a DSG channel filter constructing unit 420.

The cable modem 410 receives a DSG channel information message transmitted in a form of a multicast via a DSG tunnel corresponding to a selected DSG tunnel address.

The DSG channel filter constructing unit 420 constructs a DSG channel filter that performs filtering of received data using the DSG channel information message.

The cable modem 410 receives data filtered through the DSG channel filter.

In this instance, the filtered data may include at least one of SI information, conditional access information, and EPG information.

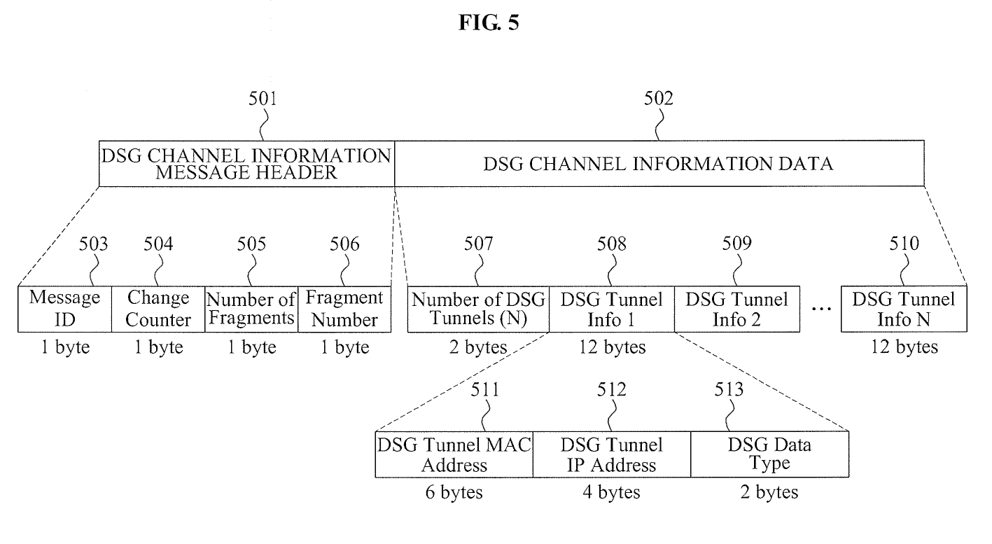

FIG. 5 is a diagram illustrating a configuration of a DSG channel information message that is provided by a DSG channel information server, according to an embodiment of the present invention.

The DSG channel information message includes a DSG channel information message header 501 including message identification information and the like, and a DSG channel information data 502 including DSG channel information.

The DSG channel information message header 501 includes a message identification (ID) 503 for identifying a message, a change counter 504 increasing a value by one when the DSG channel information is changed, thereby determining whether the message is changed, and a number of fragments 505 and a fragment number 506 providing connection information of a message.

The DSG channel information data 502 including the DSG channel construction information includes a number of DSG tunnels 507 indicating a number of DSG tunnels constructed from the broadcasting headend, and a plurality of DSG tunnel information 508, 509, and 510 including filtering information of the DSG tunnels.

Each of the DSG tunnel information 508, 509, and 510 includes a DSG tunnel MAC address 511 for identifying broadcasting additional information data and for filtering, a DSG tunnel IP address 512 providing a source IP address of a server that transmits corresponding data, and a DSG data type 513 indicating data type of received data.

The cable modem of the cable broadcasting receptor that receives the message constituted as described above, may construct a DSG channel filter according to received information and may transmit filtered data to each process module of the broadcasting receptor according to a use.

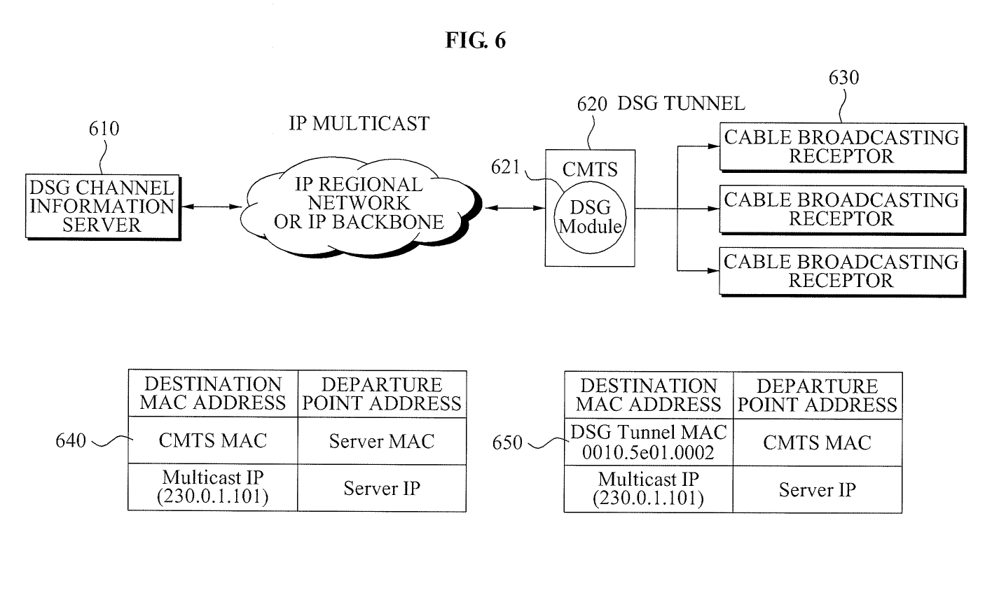

FIG. 6 is a diagram illustrating a method of changing a destination MAC address of a DSG channel information server packet in a CMTS, according to an embodiment of the present invention.

As illustrated in FIG. 6, a DSG channel information message transmitted to the CMTS 620 from a DSG channel information server 610 is transmitted in a form of an IP multicast to CMTS 620.

A DSG module 621 included in the CMTS 620 receives packets having a designated IP multicast address, and changes a destination MAC address 640 of the corresponding packets into a predetermine DSG tunnel address 650.

Information where the DSG tunnel address 650 and the multicast IP address used for data transmission are mapped is freely changed in a multicast address area according to a set value. In this instance, an initial DSG tunnel address used for transmitting the DSG channel information may be a mutually agreed upon value between a broadcasting headend and a broadcasting receptor, in advance.

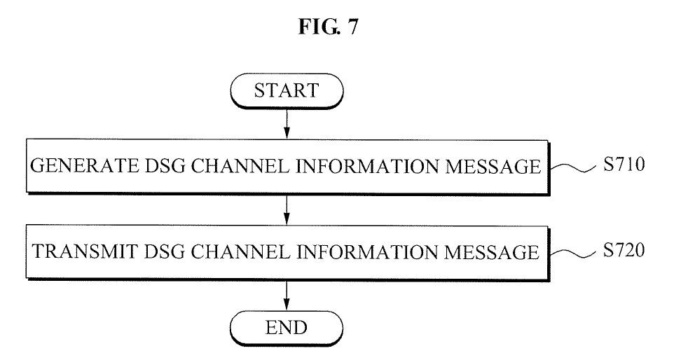

FIG. 7 is a flowchart illustrating a method of controlling a DSG channel information server according to an embodiment of the present invention.

As illustrated in FIG. 7, a DSG packet information message generating unit generates a DSG channel information message including a destination MAC address used for filtering packets for each data type in operation S710, the destination MAC address being included in each of the packets.

In this instance, the DSG channel information message includes information used for filtering the packets for each type.

Subsequently, the transmitting unit transmits the DSG channel information message to a cable broadcasting receptor using a predetermined multicast address in operation S720.

That is, the DSG channel information message transmitted by the transmitting unit may be transmitted to a CMTS, and also may be transmitted to the cable broadcasting receptor by a DSG module included in the CMTS.

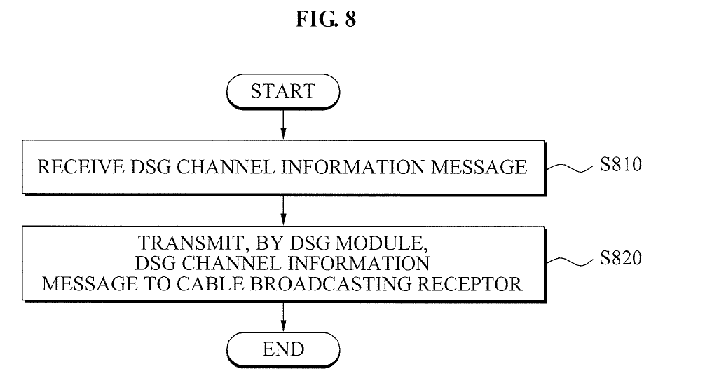

FIG. 8 is a flowchart illustrating a method of controlling a CMTS according to an embodiment of the present invention.

As illustrated in FIG. 8, a receptor receives a DSG channel information message including a destination MAC address used for filtering packets for each data type in operation S810, the destination MAC address being included in each of the packets.

Subsequently, a DSG module transmits the DSG channel information message in a form of a multicast to a cable broadcasting receptor in operation S820.

In this instance, the DSG module changes the destination MAC address into a DSG tunnel address, and transmits the DSG channel information message including the destination MAC address in the form of the multicast to the cable broadcasting receptor.

Also, the DSG module selects a predetermined address from a multicast address area and transmits the DSG channel information message in the form of the multicast to the cable broadcasting receptor.

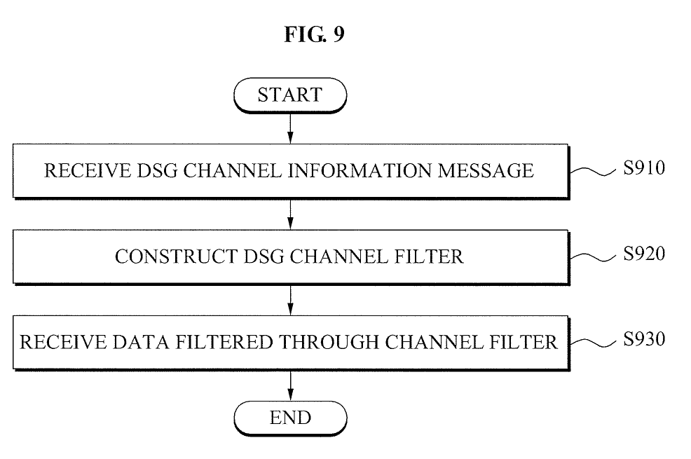

FIG. 9 is a flowchart illustrating a method of controlling a cable broadcasting receptor according to an embodiment of the present invention.

As illustrated in FIG. 9, a cable modem receives a DSG channel information message transmitted in a form of a multicast via a DSG tunnel corresponding to a predetermined DSG tunnel address in operation S910.

Subsequently, a DSG channel filter constructing unit constructs a DSG channel filter that performs filtering of received data using the DSG channel information message in operation S920.

Data filtered through the constructed DSG channel filter is received in operation S930, and the data is transmitted to a corresponding process module according to a data type.

In this instance, the filtered data may include at least one of SI information, conditional access information, and EPG information.

Accordingly, it is possible to transmit DSG channel construction information to a designated channel without replacing the devices operated in the DSG basic mode, such as a CMTS, a cable modem, and the like, with devices of DSG advanced mode and thus, the DSG channel is dynamically constructed.

According to an exemplary embodiments of the present invention, there may be provided a method of transmitting DSG channel construction information to a designated channel without replacing the devices operated in the DSG basic mode, such as a CMTS, a cable modem, and the like, with devices of DSG advanced mode, thereby dynamically constructing the DSG channel even in a device in a DSG basic mode.

Accordingly, cost expended for replacing the existing device, to utilize all advantages in the DSG advanced mode, may be reduced, and a DSG basic mode-based cable modem-containing cable broadcasting receptor may have the advantages of the device in DSG advanced mode by merely changing software.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of controlling a data over cable service interface specification (DOCSIS) set-top gateway (DSG) channel information server, comprising:
generating a DSG channel information message including a destination media access control (MAC) address used for filtering packets for each data type, the destination MAC address being included in each of the packets; and
transmitting the DSG channel information message to a cable broadcasting receptor using a predetermined multicast address.

2. The method of claim 1, wherein the transmitting of the DSG channel information message comprises providing the DSG channel information message to a cable modem termination system (CMTS), and transmitting, by a DSG module included in the CMTS, the DSG channel information message in a form of a multicast to the cable broadcasting receptor.

3. The method of claim 1, wherein the DSG channel information message includes information used for filtering the packets for each data type.

4. The method of claim 1, wherein the DSG channel information message comprises:
a DSG channel information message header including identification information of the DSG channel information message; and
DSG channel information data including DSG channel information.

5. The method of claim 4, wherein the DSG channel information message header comprises:
a message identification (ID) to identify the DSG channel information message;
a change counter to enable determining of whether the DSG channel information message is changed by changing a value according to a change of the DSG channel information; and
a number of fragments and a fragment number to provide connection information of the DSG channel information message header.

6. The method of claim 4, wherein the DSG channel information data comprises:
a number of DSG tunnels being information related to the number of the DSG tunnels constructed from a broadcasting headend; and
DSG tunnel information including filtering information of the DSG tunnels.

7. The method of claim 6, wherein the DSG tunnel information comprises:
a DSG tunnel MAC address to be used for identifying and filtering additional broadcasting information data;
a DSG tunnel Internet protocol (IP) address to provide a source IP address of a server that transmits the DSG channel information data; and
a DSG data type to represent a data type of the DSG channel information data.

8. A method of controlling a CMTS, the method comprising:
receiving a DSG channel information message including a destination MAC address used for filtering packets for each data type, the destination MAC address being included in each of the packets; and
transmitting, by a DSG module, the DSG channel information message in a form of a multicast, to a cable broadcasting receptor.

9. The method of claim 8, wherein the transmitting of the DSG channel information message comprises:
changing, by the DSG module, the destination MAC address into a DSG tunnel address, and transmitting the DSG channel information message including the destination MAC address in the form of the multicast, to a cable broadcasting receptor.

10. The method of claim 8, wherein the transmitting of the DSG channel information message comprises:
selecting, by the DSG module, a predetermined address from a multicast address area, and transmitting the DSG channel information message in the form of the multicast, to the cable broadcasting receptor.

11. A method of controlling a cable broadcasting receptor, the method comprising:
receiving a DSG channel information message transmitted in a form of a multicast via a DSG tunnel corresponding to a predetermined DSG tunnel address;
constructing a DSG channel filter that performs filtering of received data using the DSG channel information message; and
receiving data filtered by the DSG channel filter.

12. The method of claim 11, wherein the filtered data includes broadcasting additional information including at least one of system information (SI), conditional access information, and an electronic program guide (EPG) information.

13. A DSG channel information server, comprising:
a DSG channel information message generating unit to generate a DSG channel information message including a destination MAC address used for filtering packets for each data type, the destination MAC being included in each of the packets; and
a transmitting unit to transmit the DSG channel information message to a cable broadcasting receptor using a predetermined multicast address.

14. The DSG channel information server of claim 13, wherein the transmitting unit provides the DSG channel information message to a CMTS and enables a DSG module included in the CMTS to transmit the DSG channel information message in a form of a multicast to a cable broadcasting receptor.

15. A CMTS, comprising:
a receiving unit to receive a DSG channel information message including a destination MAC address used for filtering packets for each data type, the destination MAC address being included in each of the packets; and
a DSG module to transmit the DSG channel information message in a form of a multicast to a cable broadcasting receptor.

16. The CMTS of claim 15, wherein the DSG module changes the destination MAC address into a DSG tunnel address, and transmits the DSG channel information message including the destination address in the form of the multicast to the cable broadcasting receptor.

17. The CMTS of claim 15, wherein the DSG module selects a predetermined address from a multicast address area, and transmits the DSG channel information message in the form of the multicast to the cable broadcasting receptor.

18. A cable broadcasting receptor, comprising:
a cable modem to receive a DSG channel information message transmitted in a form of multicast through a DSG tunnel corresponding to a predetermined DSG tunnel address; and
a DSG channel filter constructing unit to construct a DSG channel filter to perform filtering of received data using the DSG channel information message,
wherein the cable modem receives data filtered through the DSG channel filter.

19. The cable broadcasting receptor of claim 18, wherein the filtered data includes broadcasting additional information including at least one of SI, conditional access information, and EPG information.
